(19) United States
(12) Patent Application Publication
(10) Pub. No.: US 2017/0286254 A1
(43) Pub. Date: Oct. 5, 2017

(54) METHOD AND APPARATUS FOR USING TARGET OR UNIT UNDER TEST (UUT) AS DEBUGGER

(71) Applicant: Intel Corporation, Santa Clara, CA (US)

(72) Inventors: Sankaran M. Menon, Austin, TX (US); Rolf H. Kuehnis, Portland, OR (US); William H. Penner, Olympia, WA (US); Pronay Dutta, Beaverton, OR (US)

(21) Appl. No.: 15/085,733

(22) Filed: Mar. 30, 2016

(51) Int. Cl. G06F 11/36

(52) U.S. Cl. CPC G06F 11/364

(57) ABSTRACT

A method and apparatus for collecting debug and crash information are described. In one embodiment, a system comprises one or more compute engines an external interface; a non-volatile memory coupled to the external interface and operable to store captured information, wherein the captured information comprises one or both of debug information and crash information; a first trace aggregator coupled to the non-volatile memory and the one or more compute engines to capture the one or both of debug information and crash information from at least one of the one or more compute engines in response to a crash of the system; and a controller, coupled to the non-volatile memory and the first trace aggregator, to cause captured information to be sent from the first trace aggregator to the non-volatile memory and to subsequently control transfer of the captured information stored in the non-volatile memory to the external interface.

### FIELD OF THE INVENTION

Embodiments of the present invention relate to the field of debugging; more particularly, embodiments of the present invention relate to capturing and aggregating debug traces by the target without the intervention of any external debugger, and providing those aggregated traces to an interface of the target where the captured traces may be stored and/or transferred to a remote location for subsequent debug analysis.

### BACKGROUND OF THE INVENTION

Today's systems and platforms comprising of Systems-on-Chips (SoCs) and integrated circuits (ICs) are debugged by connecting the Target or Unit under Test (UUT) to a debugger using a cable or a set of cables. Typically, one cable is used for debugging, which conceptually carries two functions, one is for control purposes and is generally connected to a JTAG port while the other is for debug tracing connected to a system output trace port. FIG. 1 illustrates a debugger interfacing with a target system via a Joint Test Action Group (JTAG) port and a trace port. Referring to FIG. 1, JTAG port connection 101 between the Debugger and the Target System (DTS) 100 along with Trace port 102 are used to send streaming traces from Target System (TS) 104 to DTS 100. DTS 100 may be a host computer, while TS 104 may be a smartphone, tablet, laptop, etc.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a debugger interfacing with a target system via a Joint Test Action Group (JTAG) port and a Trace port.

FIG. 2 illustrates one embodiment of a system arrangement showing a target and an external interface coupled to a memory to collect traces for debug.

FIG. 3 illustrates one embodiment of a target system that saves captured debug traces on an external storage device using an embedded controller.

FIG. 4 shows a scheme for firmware/software debug by saving traces on external storage device.

FIG. 5 illustrates a scheme for low power debug.

FIG. 6 illustrates a scheme for early boot and low power debug scheme where the PHY and the controllers are put on a different power-well that persists during and after “Warm-Reset”.

FIG. 7 illustrates one embodiment of a timing diagram of the warm-reset early boot debug tracing.

FIG. 8 illustrates a debug scheme that uses the low power SRAM.

FIG. 9 is a flow diagram of one embodiment of a process for performing debugging.

FIG. 10 is a block diagram of one embodiment of a system level diagram

### DETAILED DESCRIPTION OF THE PRESENT INVENTION

Methods and apparatuses for collecting, by a target, crash and debug information that can be taken to another system to do post-mortem analysis to analyze the reasons for the crash as well as to perform a detailed debug operation are described. In one embodiment, the techniques described herein use a fast interface (e.g. USB, Thunderbolt, etc.) on the Unit under Test (UUT) that captures the debug traces for on-site debug or off-site debug in the event of a crash. In one embodiment, the off-site debug is performed in a remote location (e.g., the cloud) and this feature enables product customers to upload debug traces to such a remote location cloud for access by the company that produces the product to perform the debug/triage.

In one embodiment, the techniques described herein are used to capture firmware or software traces via USB thumb-drive (e.g., flash memory drive) or similar memory on the Unit under Test itself for debug on-site or off-site. In another embodiment, instead of using a Universal Serial Bus (USB) thumb-drive (e.g., flash memory drive) or similar memory for capturing the debug traces, wireless debugging techniques are used, such as, for example, Bluetooth Low Energy (BT-LE), WiFi, Wireless Gigabit Alliance (WiGig), 3G, 4G, Long-Term Evolution (LTE), 5G wireless technologies, etc.

By sending the crash and debug information to the company via a thumb-drive (or other memory or sending it to a remotely accessible server (e.g., a cloud server) for access by a company to debug and root-cause the issue, the company can avoid proprietary debug or ultra-sensitive debug as well as sending personnel to debug to the location of the product that crashed, thereby saving cost. This does not preclude using wireless debug techniques such as BT-LE, WiFi, WiGig 3G, 4G, LTE, 5G wireless technologies etc., instead of using thumb-drive or flash-drive for capturing the debug traces.

In one embodiment, the techniques described herein enables low-power debug without using an external debugger, by using the Unit under Test itself as the debugger. This is advantageous because debugging low-power failures on a system are extremely difficult.

In one embodiment, the techniques described herein enable performing early-boot debug by using the Target itself and without connecting any external debugger.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

### Overview

There are a number of drawbacks to using the current debugging arrangements. One such drawback is that the debugger may not be available when a system crash occurs. Also, such an arrangement does not allow for obtaining the system crash and debug information if no debugger is attached to the target system.

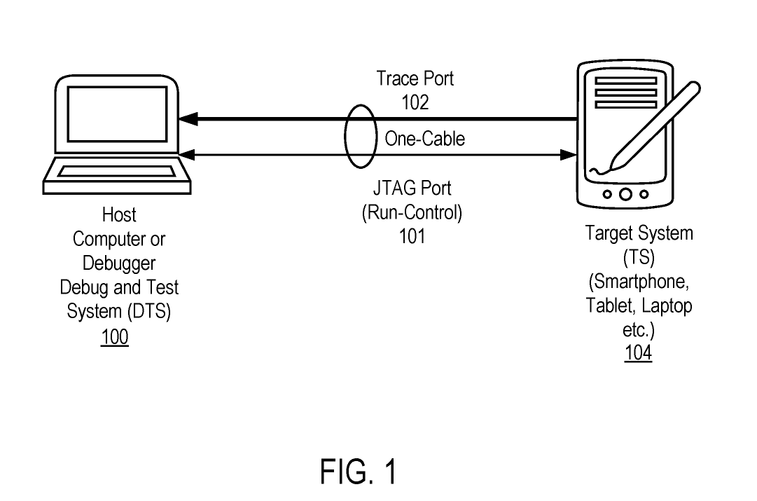

In open-chassis debug, the JTAG Test Access Port (TAP) interface as well as the Trace output provided by a trace aggregator are brought out over general purpose input/output (GPIO) pins. However, for closed chassis debug, additional logic and multiplexing are done on the System-on-Chip (SoC) as well as the platform to provide access to JTAG and trace information over available interfaces on the platform, such as Universal Serial Bus (USB), Peripheral Component Interface Express (PCIe), DisplayPort etc. For traditional testing using debuggers, the debugger interfaces with the JTAG port as well as the trace port over functional connectors such as USB, PCIe, DisplayPort etc., are used to perform Run-Control as well as Tracing, similar to what is shown in FIG. 1.

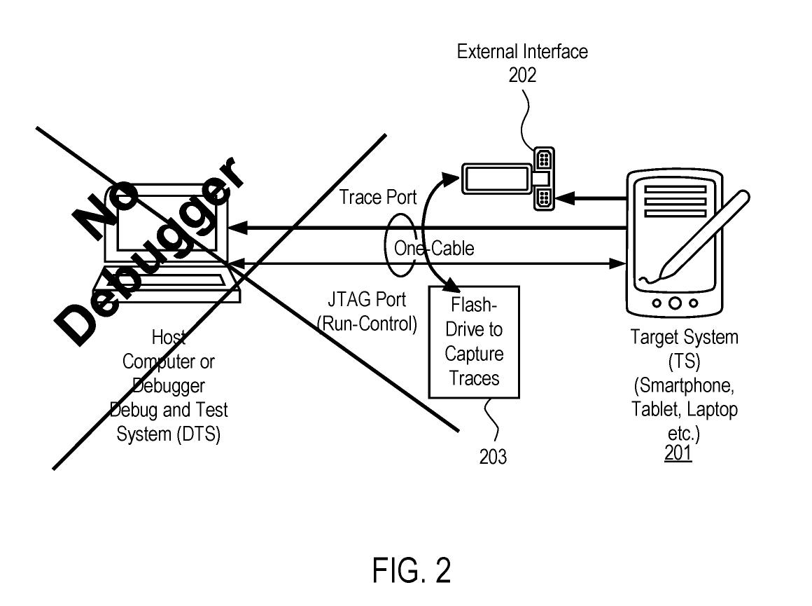

In order to capture the trace without the debugger, the traces are capture over one of the existing functional interfaces on the Target. FIG. 2 illustrates one embodiment of a system arrangement showing a target and an external interface coupled to a memory to collect traces for debug. Referring to FIG. 2, target system 201 has an external interface 202 that is coupled to a storage device 203. During a system crash, debug traces and other crash information is captured by target system 201 and sent to storage device 203 via external interface 202 for storage. Once in memory, the captured debug information may be accessed or sent for post-processing to perform debug.

Target system 201 comprises a smartphone, tablet, laptop, IoT (Internet of Things), SmartTV, car, server, or any other portable device. In one embodiment, target system 201 comprises a non-portable device. In one embodiment, external interface 202 comprises a USB interface (e.g., a USB Type-C connector). The techniques described herein are not limited to an USB Type-C interface. Other well-known interfaces or connectors may be used (e.g., Type-A, Thunderbolt, wireless interfaces, etc.). In another embodiment, external interface 202 may be replaced with a wireless link (e.g., a WiFi link, 3G/4G/LTE/5G, or other wireless links, etc.). As shown, Target system 201 has with a Type-C connector and a Flashdrive collects traces for debug.

In one embodiment, storage device 203 comprises a thumb-drive (e.g., a USB thumb-drive) or flash-drive. By capturing the traces on a USB thumb-drive or a flash-drive in and around a system failure or a system crash, the trace or the log can then be taken to a system or shipped to a site for post-processing. This alleviates a lot of expense for Original Equipment Manufacturers (OEMs) and Original Device Manufacturers (ODMs) (collectively referred to herein as OxMs) from purchasing expensive debuggers and they can capture the trace and send it to a company for post-processing and analysis.

In one embodiment, storage device 203 does not have to be coupled to target system 201 when the crash occurred. In such a case, target system 201 captures the traces and stores them until storage device 203 is coupled to external interface 202. After coupling memory 203 to external interface 202, the captured debug information is transferred by target system 201 to storage device 203.

Also, in one embodiment, the captured debug information could be transferred to another device that is coupled to the external interface 202. For example, if storage device 203 is not coupled to external interface 202, and a personal computer or other device is coupled to external interface 202, the captured debug information could be transferred to such a device. In such a case, the device becomes the “memory”.

In certain cases, whenever there is a system failure at an OxM site, and if it involves debugging that may require access to vendor specific information (e.g., confidential information) stored in the chip in target system 201, the vendor requires that one of its employee(s) travel to the site and do an unlock operation for debugging. This is an expensive proposition. In one embodiment, the chip/SoC manufacturer or OxMs provide software (e.g., a script) that can be run on the target system by a compute engine, or element (e.g., CPU, micro controller unit (MCU), etc.) and causes traces to be captured and stored on the memory (e.g., thumb-drive) by the chip/SoC manufacturer or OxMs and sent for post-processing and analysis to troubleshoot and debug the failure. More specifically, execution of the script causes debug information to be captured and stored in the target system and then provided to the memory via an external interface. The memory storing the captured debug information itself could be sent via mail to the chip/SoC manufacturer or OxM for processing and analysis. Alternatively, the captured traces can be sent via email or other transfer mechanism. Also, the captured traces can be uploaded to a remote location (e.g., the cloud) or stored on a secure server for access by the chip/SoC manufacturer or OxM so that they can access the debug traces and do post-processing. This saves a tremendous amount of time and money for an OxM.

Note that today's software debugging capability does allow storing of logs in the local storage, and in order to do so, the operating system (OS) software must be running. However, the use of techniques described herein does not have any dependency on the OS and enables debugging of issues preventing the OS from being loaded as well as issues that occur before the OS is loaded.

There are a number of alternatives that may be employed using the techniques described herein. These are described below.

### Target-Based CrashDump and CrashLog

For example, the techniques described herein may be used for target-based CrashDump and CrashLog. That is, in one embodiment, CrashDump/CrashLog information is captured and stored in a flash-drive (or other storage device) connected over a USB (or other) port. At that point, the captured information may be taken to another on-site or off-site debugger where the failing scenario is debugged.

CrashDump and CrashLog are features to enable the collection and extraction of useful debug information when the system is in a catastrophic or fatal error state or also known as System crash. Hangs that occur on the field and during production volume ramp are very difficult to debug and time to debug is extremely critical. Some of these failures create a large amount of support issues for our customers and potentially cause product launch issues as well. As a result, customers want to easily/efficiently extract data for root-causing.

The term CrashDump refers to herein the ability to perform the extraction of information while the component(s) or silicon die(s) are in the error state prior to a RESET event by a sideband access mechanism. The term CrashLog refers to herein the ability to extract information about a failure state after the system has been RESET and functionality is restored enough to allow for the data extraction by the system firmware executing on the target. The purpose of both these are to enable triage of a system failure to enable repair, replacement or changes to a platform to enable correct operation. The purpose is to provide sufficient information for full root cause analysis in one dump event.

In either case, once the CrashDump/CrashLog information is available in a non-volatile memory on the system, the information is downloaded to a storage device via an external interface, such as, for example, a USB interface. This does not preclude using other techniques such as wireless capture capabilities using BT-LE, WiFi, WiGig, near field communication (NFC), 3G/4G/LTE/5G wireless technologies, etc., to capture the debug traces of other interfaces.

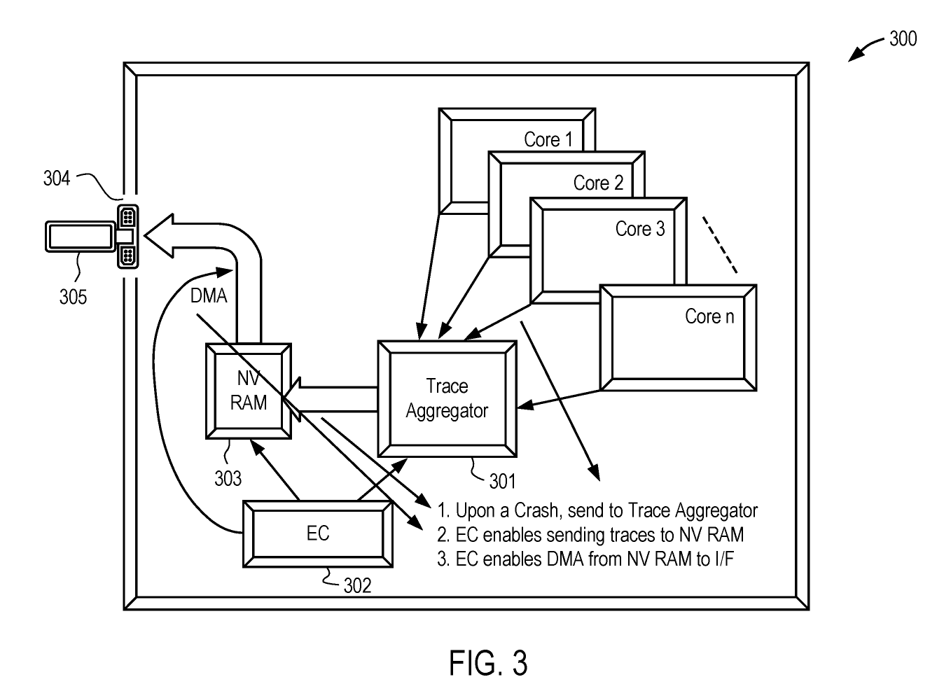

FIG. 3 illustrates one embodiment of a target system that saves captured debug traces on an external storage device using an embedded controller. Upon occurrence of a CrashDump/CrashLog, the traces are automatically sent to an external storage device (e.g., a USB Thumb-drive), which allows the captured traces to be taken out and either analyzed immediately or can be sent or uploaded to a central location (e.g., a Cloud) for post-mortem or post-processing and analysis.

Referring to FIG. 3, target 300 includes multiple cores, shown as cores 1 to n. Upon the occurrence of a crash, cores 1 to n send debug traces to trace aggregator 301. In one embodiment, these traces are for CrashDump and/or CrashLog. In one embodiment, trace aggregator 301 is a separate component from any and all of cores 1 to n. In another embodiment, trace aggregator 301 is part of one of cores 1 to n. Note that while cores 1 to n are shown, cores 1 to n could be replaced with embedded controllers, processors, micro controllers, digital signal processors (DSPs), sequencers, or other compute engines.

An embedded controller (EC) 302 enables these aggregated traces to be transferred to a Non-Volatile RAM (NVRAM) 303 from trace aggregator 301. NVRAM 303 persists power-cycle or any catastrophic events. Alternatively, NVRAM 303 may be any memory that survives power-cycle or any catastrophic events.

EC 302 is then used to transfer the traces from NVRAM 303 to an external location via external interface 304 (e.g., Type-C connector, etc.). In one embodiment, the external location comprises an external storage device 305 (e.g., USB thumb-drive, flash-drive, etc.). In one embodiment, EC 302 is then used to transfer the traces in NVRAM 303 to the external USB thumb-drive via external interface 304. In one embodiment, the transfer from NVRAM 303 to external storage device 305 is via direct memory access (DMA). In one embodiment, EC 302 is programmed to perform all these functions.

In one embodiment, the captured debug information may be encrypted prior to storage on external storage device 305. The encryption may be performed by trace aggregator 301 or another component in target system 300. The encryption may be performed before the captured trace information is stored in NVRAM 303 or after it has been stored in NVRAM 303.

Note that in one embodiment the operations depicted in FIG. 3 are performed in hardware and are performed independently of the operating system.

In one embodiment, triggering logic is included in target system 300 to start and stop the traces based on an event or signal pattern to limit the amount of data captured or to signal when to initiate the crash event to cause the crash information to be written to the NVRAM 303. In one embodiment, triggering logic is part of trace aggregator 301. In another embodiment, the triggering logic is part of an embedded controller (not shown) that signals each of cores 1-n to control (e.g., start and stop traces) each of cores 1-n with respect to trace transfer. This trigger mode of operation can enable both software and firmware debug and hardware logic debug for cases that do not normally result in a system crash or normally trigger the crash logic. The triggering logic need not necessarily be part of the trace aggregator, instead in one embodiment, it can be another logic block that enables triggering whenever any software/firmware or hardware errors occur enabling traces to be captured in NVRAM 303.

### Target-Based Software/Firmware Debug

Software and Firmware Debug is an important aspect of debug. There are several micro-controllers on the present day SoCs that run firmware and they all need firmware debug capability. Some of the firmware engines on SoCs are referred to as power unit (Punit) firmware, Power Management Controller (PMC) firmware, audio firmware, Integrated Sensor Hub (ISH) firmware, security firmware, video firmware (FW) engine, Type-C firmware, etc. All these firmware components need debug capability.

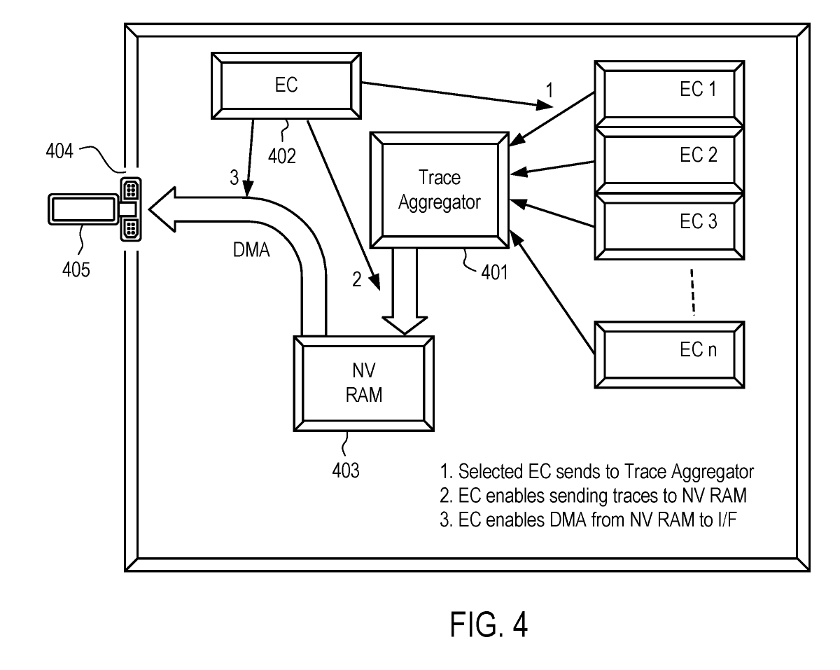

In one embodiment, one or more embedded controllers (ECs) can be used to trace the execution of the rest of the ECs and to send the traces to the trace aggregator. In one embodiment, the EC also controls sending the debug traces from the trace aggregator to the NVRAM, from which the captured debug traces are sent out to the Type-C connector via the USB interface by way of DMA to the external storage device. FIG. 4 shows a scheme for firmware/software debug by saving traces on external storage device. These firmware (FW) traces that are gathered are sent to on-site or off-site for debug and postmortem analysis.

Referring to FIG. 4, EC 402 selects one or more of ECs 1-n to send its debug traces to trace aggregator 401. EC 402 also enables the captured and aggregated debug traces to be sent from trace aggregator 401 to NVRAM 403 and then enables their transfer from NVRAM 403 to an external location via external interface 404 (e.g., Type-C connector, etc.). In one embodiment, the external location comprises an external storage device 405 (e.g., USB thumb-drive, flash-drive, etc.). The transfer from NVRAM 403 to an external location via external interface 404 may be by DMA.

If a failure does occur, EC 402 may not know which EC had the failure. In such a case, in one embodiment, EC 402 signals each of ECs 1 to n to determine which had a failure and then signals those with failures to send their debug traces to trace aggregator 401.

### Target-Based Low-Power Debug

Low power debug is extremely important as majority of the failures seen when first silicon arrives are related to low power debug. In one embodiment, for low-power debug, the low-power traces are sent to a low power trace aggregator and are saved, using an embedded controller, in a memory (e.g., NVRAM) in the target system. This enables debug of S0ix as well as when the system is in an active power state. That is, when a system transitions between running normally and entering reduced power consumption states repeatedly, debugging such low-power scenarios are extremely difficult.

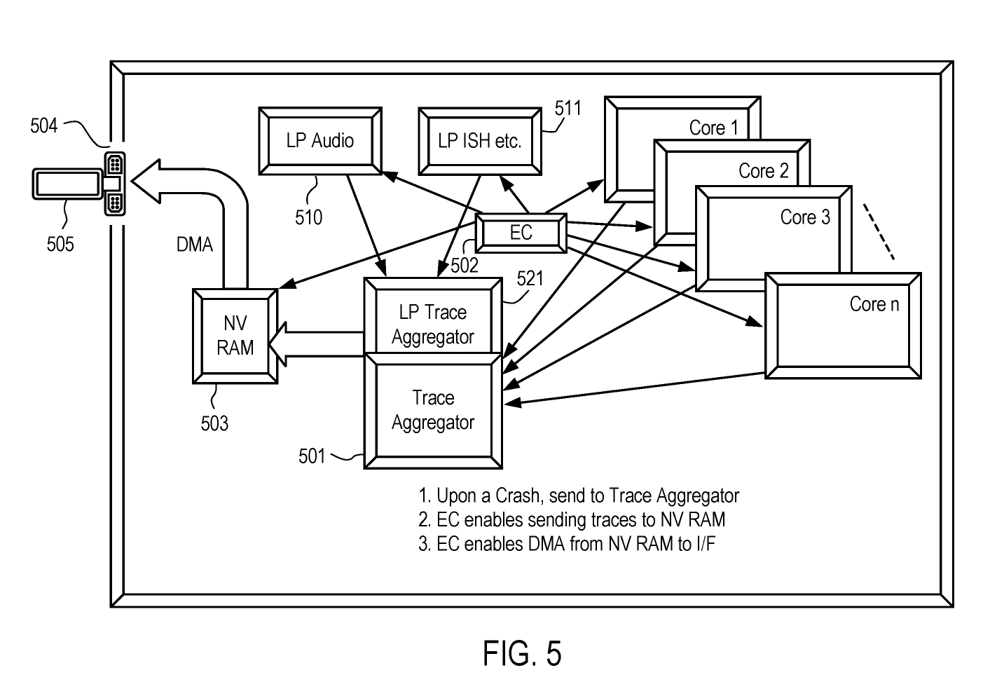

FIG. 5 illustrates a scheme for low power debug. Referring to FIG. 5, both the low power traces as well as the high-performance traces are pushed into the aggregator. Low Power Traces are traces that are from the low power units, such as, for example, PMC (Power Management Controller), Audio unit, SCU (System Control Unit), ISH (Integrated Services Hub), etc., while other units (e.g., CPU, etc.) are powered off. These are units that come up initially while booting the system way before the CPU comes up. Also, in one embodiment, the CPU and a North complex (which includes CPU and a memory controller and a system Agent) may be turned off while playing just the audio or if the CPU is not required for any services. In this scenario, the traces are only sent by the low power units, which are known as low power traces. More specifically, EC 502 selects one or more of processing units, such as cores 1-n, audio processing unit 510 (e.g., Low Power (LP) Audio), LP Integrated Sensor Hub (ISH) 511, etc. to send debug traces to a trace aggregator. When a crash occurs, cores 1 to n send their debug traces to trace aggregator 501, while audio processing unit 510, LP ISH 511, etc. send their debug traces to a LP trace aggregator 521. In other words, the traces are collected when going through power transitions. EC 502 also enables the captured and aggregated debug traces to be sent from trace aggregator 501 and LP trace aggregator 521 to NVRAM 503 and then enables their transfer from NVRAM 503 to an external location via external interface 504 (e.g., Type-C connector, etc.). Note that both a low power aggregator and a high-performance trace aggregator are not needed. Both may be included in one trace aggregator for simplicity of implementation and they are power-partitioned to accept traces and to keep the power dissipation low.

In one embodiment, the external location comprises an external storage device 505 (e.g., USB thumb-drive, flash-drive, etc.). The transfer from NVRAM 503 to an external location via external interface 504 may be by DMA. Thus, in one embodiment, EC 502 causes the traces to be pushed to NVRAM 503 and in turn uses DMA to transfer them to the external flash-drive or thumb-drive.

### Target-Based Early-Boot Debug

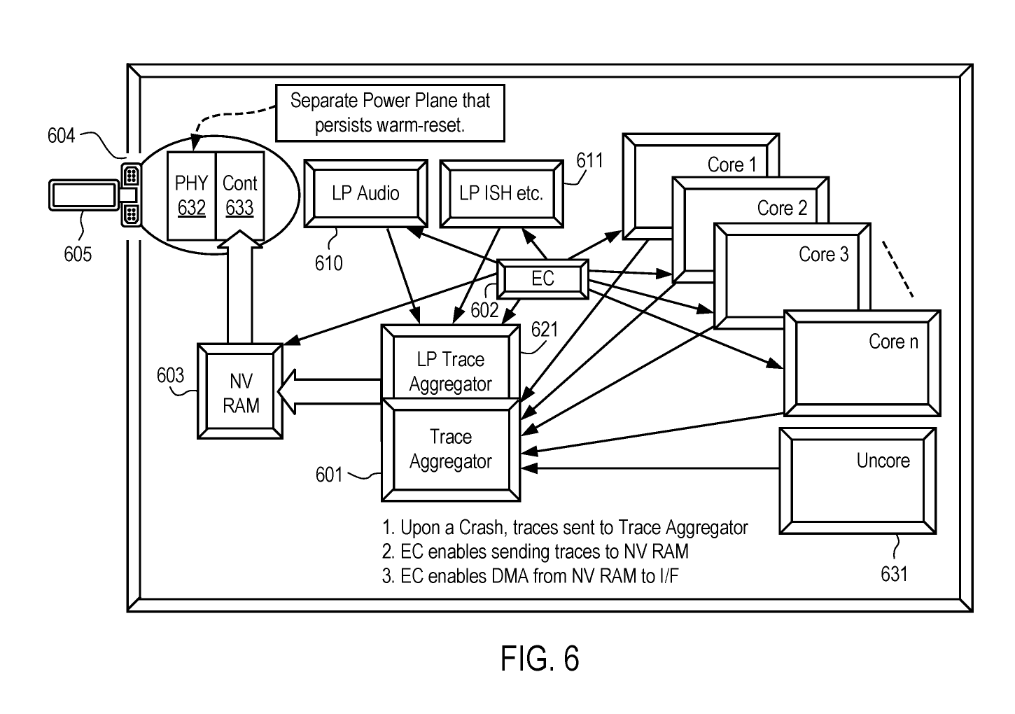

Early-boot debug scenarios are one of the most difficult scenarios to debug because the “plumbing path” or the path to provide output observability during very early stages of early-boot is not initialized, resulting in a big “blind-spot” during early-boot debug. In one embodiment, the early-boot debug traces are captured without the need for a debugger. However, since the sequence to power up the USB-PHY and controller takes very many cycles, in one embodiment, the USB-PHY and the USB-Controller are powered up, even during the time that a warm-reset occurs. Then, a “Warm-Reset” is performed to start capturing the traces as the system is coming up in the early-boot phase. Warm Reset is defined as a software controlled reset. This may result from either pressing the reset button on a desktop system or holding the power button continuously (without powering the unit off) to reset the laptop or a device. During a warm reset, some memory content is available, such that not all information in the platform is cleared. “Early-Boot” is defined as the stages or states that a system goes through from the time the system is powered up and “reset” is initiated until the CPUs are booted up with the Operating System (OS). In one embodiment, the early-boot time is the time during which the boot loader is running to the time before the first OS instruction fetch occurs. FIG. 6 illustrates a scheme for early boot and low power debug scheme where the PHY and the controllers are put on a different power-well that persists during and after a “Warm-Reset”. In one embodiment, this is accomplished by configuring the PHY in GPIO mode. The PHY and controller may be a USB-PHY and USB controller, respectively. However, they could also be non-USB elements.

Referring to FIG. 6, as in FIG. 5, both the low power traces as well as the high-performance traces are pushed into the aggregator. More specifically, EC 602 selects one or more of processing units, such as cores 1-n, uncore 631 (e.g., input/output (I/O) interface), audio processing unit 610 (e.g., Low Power (LP) Audio), LP ISH 611, etc. to send debug traces to a trace aggregator. When a crash occurs, cores 1-n and uncore 631 send their debug traces to trace aggregator 601, while audio processing unit 610, LP ISH 611, etc. send their debug traces to a LP trace aggregator 621. EC 602 also enables the captured and aggregated debug traces to be sent from trace aggregator 601 and LP trace aggregator to NVRAM 603 and then enables their transfer from NVRAM 603 to an external location via external interface 604 (e.g., Type-C connector, USB connector, non-USB connector, etc.). In one embodiment, the external location comprises an external storage device 605 (e.g., thumb-drive, flash-drive, etc.). The transfer from NVRAM 603 to an external location via external interface 604 may be by DMA. Thus, in one embodiment, EC 602 causes the traces to be pushed to NVRAM 603 and in turn uses DMA to transfer them to the external flash-drive or thumb-drive.

As shown, PHY 632 (e.g., USB-PHY) and controller 633 (e.g., USB controller) are coupled to a separate power plane and continue to receive power during warm-reset. In alternative embodiments, when an interface other than USB is used, the PHY and controller associated with that interface may be powered in the same manner.

During normal system power-up, it may be noted that PHY 632 (e.g., USB-PHY) and controller 633 (e.g., USB controller) takes a long time to come up (compared to the early-boot scenario) before the debug traces can be sent out of external interface 604 (e.g., a USB interface) to storage device 605. By the time PHY 632 and controller 633 power up, the early-boot debug scenario has passed and cannot be observed at interface 604. The fact that PHY 632 and controller 633 do not power-up instantly to observe early-boot debug signals causes the “Blind-Spot” as mentioned above.

To avoid the “Blind-Spot”, PHY 632 and controller 633 are powered up during the first-boot and when early-boot debug is enabled (i.e., “Early-Boot_Debug_Enable=1”), and then the power-well that powers up PHY 632 and controller 633 are kept powered-up even-though “Warm-Reset” is applied. This is the reason for powering PHY 632 and controller 633 with the power-well to persist “Warm-Rest”. After the “Warm-Reset”, since PHY 632 and controller 633 continue to be powered up, traces related to the early-boot signals can be captured and transferred to external interface 604 (e.g., the USB output interface), enabling storage device 605 (e.g., a USB thumb-drive, other non-USB thumb-drive, etc.) to capture the traces.

In one embodiment, the ECs and trace aggregators get powered up after the early-boot (blind-spot). In one embodiment, the early boot traces are captured and stored in the NVRAM and sent out to external memory later.

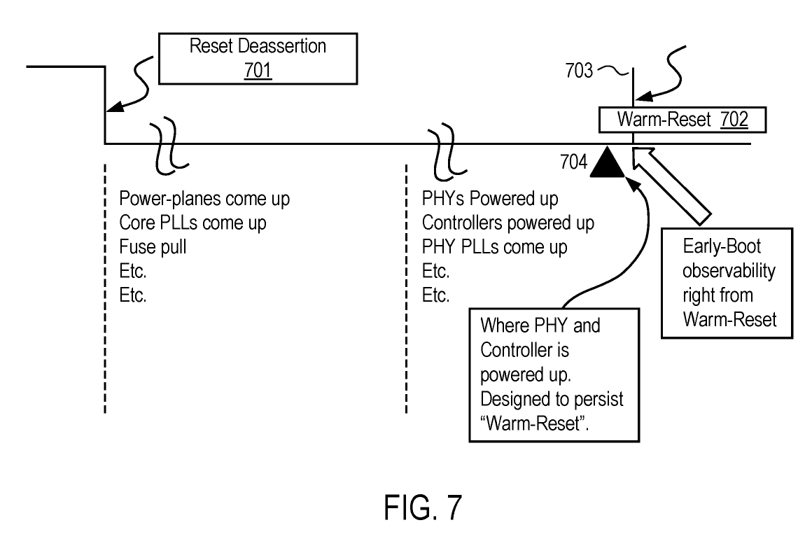

FIG. 7 illustrates one embodiment of a timing diagram of the warm-reset early boot debug tracing. Referring to FIG. 7, when reset is deasserted (701), the power planes are powered up, the core phase-locked loops (PLLs) are powered up, and other operations are begun. At a certain point after the PHYs, controllers, PHY PLLs are powered up (704), the PHY (e.g., USB-PHY) and controller (e.g., USB controller) are powered up, and a Warm Reset (702) occurs. At that point, early boot signals are observable from Warm Reset.

Once the early-boot traces are captured on the thumb-drive or flash-drive, the traces can be taken to another machine for debugging and to troubleshoot the debug scenario.

Since the traces are exposed to OxMs, to mitigate any security/privacy issues, in one embodiment, encryption is applied to the debug traces being written into external storage device (e.g., the thumb-drive) or to the output interface, whether it is, for example, Bluetooth, WiFi, WiGig or any other interface, so that no other user other than manufacturer (or party doing the debug operation) can gain access and interpret the debug traces.

There are a number of alternative embodiments to the schemes described above. In one embodiment, the traces/log file are written into the NVRAM as a circular buffer. In such a case, upon a crash, the EC sends a trigger to write the contents of the NVRAM into the external storage device (e.g., thumb-drive, flash-drive, etc.) via the external interface (e.g., a USB interface) This avoids placing the PHY and the controller in a separate power-well such as is used in the early-boot debug scheme.

In another embodiment, instead of sending the traces to external storage device that comprises a USB thumb-drive or flash-drive, the captured debug information may be written to a file-system, such as, for example, a FAT (File Allocation Table) or NTFS (New Technology File System). This enables to capture into a generic file system or a hard-drive.

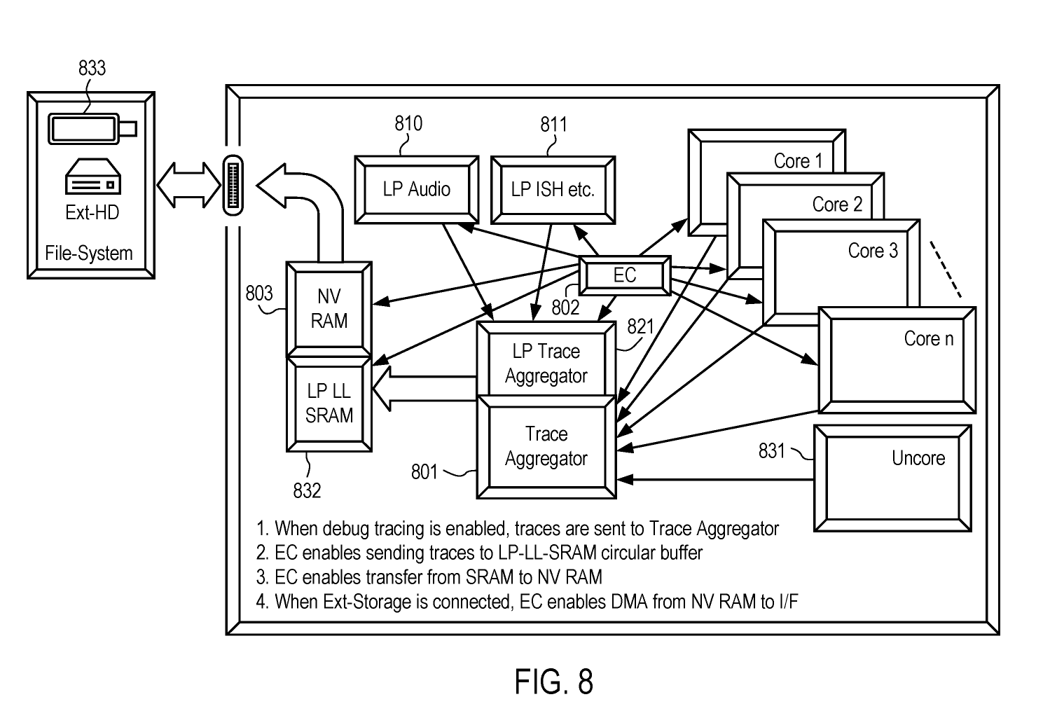

In one embodiment, the target-based CrashDump and CrashLog schemes are modified. One of the requirements of CrashDump is that the traces need to be captured prior to a reset event. This requires that the traces need to be captured before the event of interest. In order to achieve this, in one embodiment, a low-power SRAM (or other comparable memory) is used and only enabled when CrashDump/CrashLog is enabled. In one embodiment, the low power SRAM is a low-power/low-leakage LP-LL-SRAM. The traces are written into this low-power/low-leakage LP-LL-SRAM continuously as if written into a circular buffer. Upon occurrence of a crash, the traces of interest will be available in the low-power SRAM and are transferred to the NVRAM, and then the NVRAM contents are transferred out to an external storage device e.g., a flash-drive, a thumb-drive, a file-system. This scheme avoids the need to partition the power-well to keep the USB-PHY and controller to survive “warm-reset”. FIG. 8 shows an example of such scheme that uses the low power SRAM. Referring to FIG. 8, to save the crash information on external file system, when debug tracing is enabled, traces are sent to trace aggregator 801, EC 802 enables sending traces to the circular buffer in the LP-LL SRAM 832, and EC 802 enables transfer from SRAM 832 to NVRAM 803. Since traces are already stored in the NVRAM, it can stay as long as required. As and when an external storage is connected to external interface 804, EC 802 detects and start transferring the traces from NVRAM to external storage device 833, which could be a flash-drive, a thumb-drive or a file system.

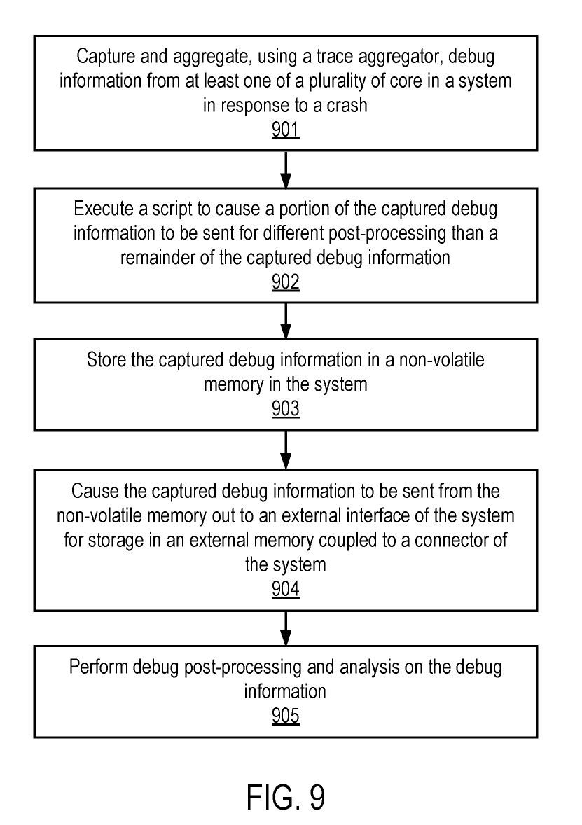

FIG. 9 is a flow diagram of one embodiment of a process for performing debugging. The process is performed by processing logic that may comprise hardware (circuitry, dedicated logic, etc.), software (such as is run on a general purpose computer system or a dedicated machine), or a combination of both.

Referring to FIG. 9, the process begins by capturing and aggregating, using a trace aggregator, debug information from at least one of a plurality of cores in a system in response to a crash (processing block 901). In one embodiment, capturing debug information comprises low-power debug information generated by at least one core operating in a reduced power consumption state. In one embodiment, the debug information is captured during an early boot process.

In one embodiment, the process further comprises executing a script to cause a portion of the captured debug information to be sent for different post-processing than a remainder of the captured debug information (processing block 902). This is optional. In one embodiment, the portion of captured debug information is vendor specific information.

Next, processing logic stores the captured debug information in a non-volatile memory in the system (processing block 903). In one embodiment, storing the captured debug information in non-volatile memory includes initially sending the captured debug information to a second memory (e.g., a low power SRAM or other low power consumption memory) and then from the second memory to the non-volatile memory.

After storing the captured debug information in a non-voltage memory, processing logic causes the captured debug information to be sent from the non-volatile memory out to an external interface of the system for storage in an external memory coupled to a connector of the system (processing block 904). In one embodiment, the external interface comprises a Type-C connector. In an alternative embodiment, the external interface is a wireless interface.

After the captured debug information has been sent through the external interface, processing logic performs debug post-processing and analysis on the debug information (processing block 905).

In one embodiment, capturing and aggregating the debug information is performed independently of the operating system.

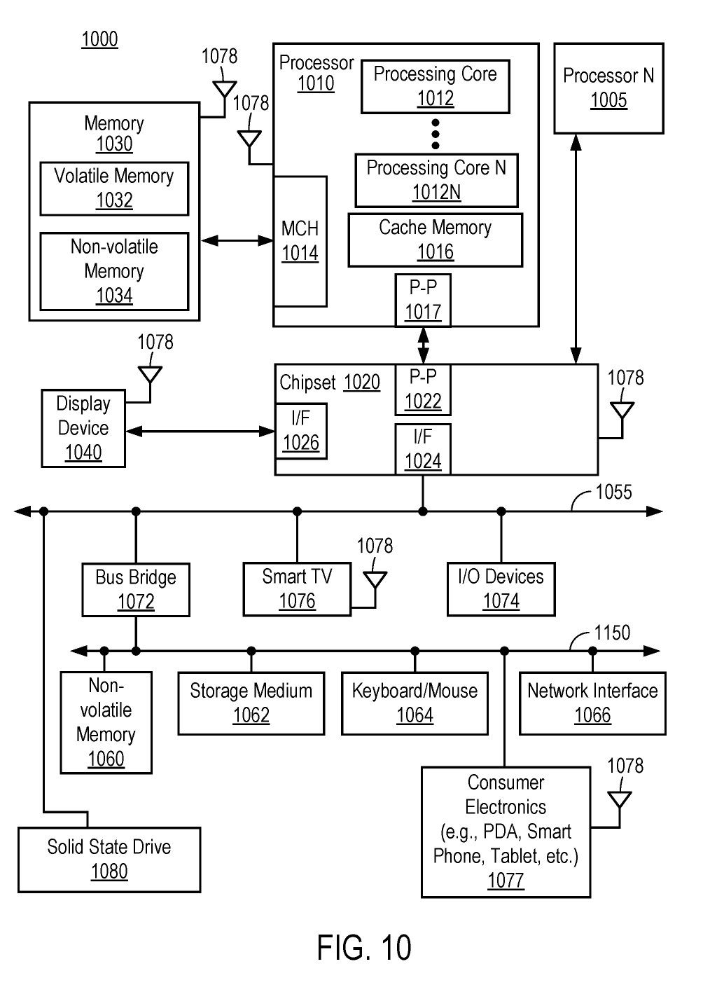

FIG. 10 is one embodiment of a system level diagram 1000 that may incorporate the techniques described above. For example, the techniques described above may be used in conjunction with a processor in system 1000 or other part of system 1000.

Referring to FIG. 10, system 1000 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In another embodiment, system 1000 implements the methods disclosed herein and may be a system on a chip (SOC) system.

In one embodiment, processor 1010 has one or more processor cores 1012 to 1012N, where 1012N represents the Nth processor core inside the processor 1010 where N is a positive integer. In one embodiment, system 1000 includes multiple processors including processors 1010 and 1005, where processor 1005 has logic similar or identical to logic of processor 1010. In one embodiment, system 1000 includes multiple processors including processors 1010 and 1005 such that processor 1005 has logic that is completely independent from the logic of processor 1010. In such an embodiment, a multi-package system 1000 is a heterogeneous multi-package system because the processors 1005 and 1010 have different logic units. In one embodiment, processing core 1012 includes, but is not limited to, pre-fetch logic to fetch instructions, decode logic to decode the instructions, execution logic to execute instructions and the like. In one embodiment, processor 1010 has a cache memory 1016 to cache instructions and/or data of the system 1000. In another embodiment of the invention, cache memory 1016 includes level one, level two and level three, cache memory, or any other configuration of the cache memory within processor 1010.

In one embodiment, processor 1010 includes a memory control hub (MCH) 1014, which is operable to perform functions that enable processor 1010 to access and communicate with a memory 1030 that includes a volatile memory 1032 and/or a non-volatile memory 1034. In one embodiment, memory control hub (MCH) 1014 is positioned outside of processor 1010 as an independent integrated circuit.

In one embodiment, processor 1010 is operable to communicate with memory 1030 and a chipset 1020. In such an embodiment, SSD 1080 executes the computer-executable instructions when SSD 1080 is powered up.

In one embodiment, processor 1010 is also coupled to a wireless antenna 1078 to communicate with any device configured to transmit and/or receive wireless signals. In one embodiment, wireless antenna interface 1078 operates in accordance with, but is not limited to, the IEEE 802.11 standard and its related family, HomePlug AV (HPAV), Ultra Wide Band (UWB), Bluetooth, WiMAX, or any form of wireless communication protocol.

In one embodiment, the volatile memory 1032 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 1034 includes, but is not limited to, flash memory (e.g., NAND, NOR), phase change memory (PCM), read-only memory (ROM), electrically erasable programmable read-only memory (EEPROM), or any other type of non-volatile memory device.

Memory 1030 stores information and instructions to be executed by processor 1010. In one embodiment, chipset 1020 connects with processor 1010 via Point-to-Point (PtP or P-P) interfaces 1017 and 1022. In one embodiment, chipset 1020 enables processor 1010 to connect to other modules in the system 1000. In one embodiment, interfaces 1017 and 1022 operate in accordance with a PtP communication protocol such as the Intel QuickPath Interconnect (QPI) or the like.

In one embodiment, chipset 1020 is operable to communicate with processor 1010, 1005, display device 1040, and other devices 1072, 1076, 1074, 1060, 1062, 1064, 1066, 1077, etc. In one embodiment, chipset 1020 is also coupled to a wireless antenna 1078 to communicate with any device configured to transmit and/or receive wireless signals.

In one embodiment, chipset 1020 connects to a display device 1040 via an interface 1026. In one embodiment, display device 1040 includes, but is not limited to, liquid crystal display (LCD), plasma, cathode ray tube (CRT) display, or any other form of visual display device. In addition, chipset 1020 connects to one or more buses 1050 and 1055 that interconnect various modules 1074, 1060, 1062, 1064, and 1066. In one embodiment, buses 1050 and 1055 may be interconnected together via a bus bridge 1072 if there is a mismatch in bus speed or communication protocol. In one embodiment, chipset 1020 couples with, but is not limited to, a non-volatile memory 1060, a mass storage device(s) 1062, a keyboard/mouse 1064, and a network interface 1066 via interface 1024, smart TV 1076, consumer electronics 1077, etc.

In one embodiment, mass storage device 1062 includes, but is not limited to, a solid state drive, a hard disk drive, a universal serial bus flash memory drive, or any other form of computer data storage medium. In one embodiment, network interface 1066 is implemented by any type of well-known network interface standard including, but not limited to, an Ethernet interface, a universal serial bus (USB) interface, a Peripheral Component Interconnect (PCI) Express interface, a wireless interface and/or any other suitable type of interface.

While the modules shown in FIG. 10 are depicted as separate blocks within the system 1000, the functions performed by some of these blocks may be integrated within a single semiconductor circuit or may be implemented using two or more separate integrated circuits.

In a first example embodiment, a system comprises one or more compute engines; an external interface; a non-volatile memory coupled to the external interface and operable to store captured information, wherein the captured information comprises one or both of debug information and crash information; a first trace aggregator coupled to the non-volatile memory and the one or more compute engines to capture the one or both of debug information and crash information from at least one of the one or more compute engines in response to a crash of the system; and a controller, coupled to the non-volatile memory and the first trace aggregator, to cause captured information to be sent from the first trace aggregator to the non-volatile memory and to subsequently control transfer of the captured information stored in the non-volatile memory to the external interface.

In another example embodiment, the subject matter of the first example embodiment can optionally include that the first trace aggregator operates independently of an operating system that is to run on the system.

In another example embodiment, the subject matter of the first example embodiment can optionally include a second trace aggregator to capture one or both of debug information and crash information generated by at least one compute engine operating in a reduced power consumption state.

In another example embodiment, the subject matter of the first example embodiment can optionally include an external interface controller coupled to control the external interface, and wherein the external interface and the external interface controller are powered during an initial boot process of the system and remain powered when the system is in a warm reset state.

In another example embodiment, the subject matter of the first example embodiment can optionally include that the external interface is operable to output the captured information captured during an early boot process.

In another example embodiment, the subject matter of the first example embodiment can optionally include that the first trace aggregator is operable to execute a script to cause a portion of the captured information to be designated for different post-processing than a remainder of the captured information. In another example embodiment, the subject matter of this example embodiment can optionally include that the portion of the captured information is vendor specific information.

In another example embodiment, the subject matter of the first example embodiment can optionally include that the captured information is encrypted.

In another example embodiment, the subject matter of the first example embodiment can optionally include that the non-volatile memory is operable as a circular buffer when storing the captured information.

In another example embodiment, the subject matter of the first example embodiment can optionally include a second memory coupled between the first trace aggregator and the non-volatile memory, wherein the controller is operable to cause the captured information to be sent from the trace aggregator to the second memory and then from the second memory to the non-volatile memory. In another example embodiment, the subject matter of the first example embodiment can optionally include that the second memory is a reduced power consumption memory.

In another example embodiment, the subject matter of the first example embodiment can optionally include that the debug information comprises debug firmware traces.

In another example embodiment, the subject matter of the first example embodiment can optionally include that the external interface comprises a Type-C connector.

In another example embodiment, the subject matter of the first example embodiment can optionally include that wherein the external interface is a wireless interface.

In another example embodiment, the subject matter of the first example embodiment can optionally include a second memory coupled to the external interface to store the stored information received through the external connector from the non-volatile memory. In another example embodiment, the subject matter of the first example embodiment can optionally include that the second memory comprises a flash memory drive, a thumb drive, or a hard drive.

In a second example embodiment, a method comprises capturing and aggregating, using a trace aggregator, information from at least one of a plurality of compute engines in a system in response to a crash, where the information is one or both of debug information and crash information; storing the captured information in a non-volatile memory in the system; and causing the captured information to be sent from the non-volatile memory to an external interface of the system for storage in an external memory via an external interface of the system.

In another example embodiment, the subject matter of the second example embodiment can optionally include that capturing and aggregating the information is performed independently of an operating system running on the system.

In another example embodiment, the subject matter of the second example embodiment can optionally include capturing low-power information generated by at least one compute engine operating in a reduced power consumption state.

In another example embodiment, the subject matter of the second example embodiment can optionally include that the information is captured during an early boot process.

In another example embodiment, the subject matter of the second example embodiment can optionally include executing a script to cause a portion of the captured information to be sent for different post-processing than a remainder of the captured information. In another example embodiment, the subject matter of this example embodiment can optionally include that the portion of the captured information is vendor specific information.

In another example embodiment, the subject matter of the second example embodiment can optionally include sending the captured information to a second memory and then from the second memory to the non-volatile memory, wherein the second memory is a reduced power consumption memory.

In another example embodiment, the subject matter of the second example embodiment can optionally include that the external interface comprises a Type-C connector.

In a third example embodiment, an article of manufacture has one or more non-transitory computer readable media storing instructions which, when executed by a system, cause the system to perform a method comprising: capturing and aggregating, using a trace aggregator, information from at least one of a plurality of compute engines in a system in response to a crash, where the information being one or both of debug information and crash information; storing the captured information in a non-volatile memory in the system; and causing the captured information to be sent from the non-volatile memory out to an external interface of the system for storage in an external memory via an external interface of the system.

In another example embodiment, the subject matter of the third example embodiment can optionally include that capturing and aggregating the information is performed independently of the operating system.

In another example embodiment, the subject matter of the third example embodiment can optionally include that the debug information comprises debug firmware traces.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A system comprising:
one or more compute engines;
an external interface;
a non-volatile memory coupled to the external interface and operable to store captured information, wherein the captured information comprises one or both of debug information and crash information;
a first trace aggregator coupled to the non-volatile memory and the one or more compute engines to capture the one or both of debug information and crash information from at least one of the one or more compute engines in response to a crash of the system; and
a controller, coupled to the non-volatile memory and the first trace aggregator, to cause captured information to be sent from the first trace aggregator to the non-volatile memory and to subsequently control transfer of the captured information stored in the non-volatile memory to the external interface.

2. The system defined in claim 1 wherein the first trace aggregator operates independently of an operating system that is to run on the system.

3. The system defined in claim 1 further comprising a second trace aggregator to capture one or both of debug and crash information generated by at least one compute engine operating in a reduced power consumption state.

4. The system defined in claim 1 further comprising an external interface controller coupled to control the external interface, and wherein the external interface and the external interface controller are powered during an initial boot process of the system and remain powered when the system is in a warm reset state.

5. The system defined in claim 4 wherein the external interface operable to output the captured information captured during an early boot process.

6. The system defined in claim 1 wherein the first trace aggregator is operable to execute a script to cause a portion of the captured information to be designated for different post-processing than a remainder of the captured information.

7. The system defined in claim 6 wherein the portion of the captured information is vendor specific information.

8. The system defined in claim 1 wherein the captured information is encrypted.

9. The system defined in claim 1 wherein the non-volatile memory is operable as a circular buffer when storing the captured information.

10. The system defined in claim 1 further comprising a second memory coupled between the first trace aggregator and the non-volatile memory, wherein the controller is operable to cause the captured information to be sent from the trace aggregator to the second memory and then from the second memory to the non-volatile memory.

11. The system defined in claim 10 wherein the second memory is a reduced power consumption memory.

12. The system defined in claim 1 wherein the debug information comprises debug firmware traces.

13. The system defined in claim 1 wherein the external interface comprises a Type-C connector.

14. The system defined in claim 1 wherein the external interface is a wireless interface.

15. The system defined in claim 1 further comprising a second memory coupled to the external interface to store the stored information received through the external interface from the non-volatile memory.

16. The system defined in claim 15 wherein the second memory comprises a flash memory drive, a thumb drive, or a hard drive.

17. A method comprising:
capturing and aggregating, using a trace aggregator, information from at least one of a plurality of compute engines in a system in response to a crash, the information being one or both of information and crash information;
storing the captured debug information in a non-volatile memory in the system; and
causing the captured information to be sent from the non-volatile memory to an external interface of the system for storage in an external memory via an external interface of the system.

18. The method defined in claim 17 wherein capturing and aggregating the information is performed independently of an operating system running on the system.

19. The method defined in claim 17 further comprising capturing low-power information generated by at least one compute engine operating in a reduced power consumption state.

20. The method defined in claim 17 wherein the information is captured during an early boot process.

21. The method defined in claim 17 further comprising executing a script to cause a portion of the captured information to be sent for different post-processing than a remainder of the captured information.

22. The method defined in claim 21 wherein the portion of the captured information is vendor specific information.

23. The method defined in claim 17 further comprising sending the captured information to a second memory and then from the second memory to the non-volatile memory, wherein the second memory is a reduced power consumption memory.

24. The method defined in claim 17 wherein the external interface comprises a Type-C connector.

25. An article of manufacture having one or more non-transitory computer readable media storing instructions which, when executed by a system, cause the system to perform a method comprising:
capturing and aggregating, using a trace aggregator, information from at least one of a plurality of compute engines in a system in response to a crash, the information being one or both of debug information and crash information;
storing the captured information in a non-volatile memory in the system; and
causing the captured information to be sent from the non-volatile memory to an external interface of the system for storage in an external memory via an external interface of the system.

26. The article of manufacture defined in claim 25 wherein capturing and aggregating the information is performed independently of the operating system.

27. The article of manufacture defined in claim 25 wherein the debug information comprises debug firmware traces.
